(19) United States
(12) Patent Application Publication
(10) Pub. No.: US 2012/0314013 A1
(43) Pub. Date: Dec. 13, 2012

(54) SHEET-FED DUPLEX PRINTING PRESS

(75) Inventors: Shuichi Takemoto, Mihara-shi (JP); Shinichiro Senoo, Mihara-shi (JP); Masahiro Taketsugu, Mihara-shi (JP); Minoru Sato, Mihara-shi (JP)

(73) Assignee: KYOCERA CORPORATION, Fushimi-ku, Kyoto (JP)

(21) Appl. No.: 13/579,931

(22) PCT Filed: Jan. 17, 2011
(86) PCT No.: PCT/JP2011/050661

§ 371 Date: Aug. 18, 2012

(30) Foreign Application Priority Data
Feb. 24, 2010 (JP) 2010-039421

(51) Int. Cl. B41J 2/01

(52) U.S. Cl. 347/102; 347/103

(57) ABSTRACT

A sheet-fed duplex printing press includes a front-surface printing unit having a first impression cylinder that can carry cut paper by rotating while holding the cut paper a first blanket cylinder that contacts the first impression cylinder and can transfer heatset ink onto a front surface of the cut paper, and a first ink jet head that can supply the heatset ink to the first blanket cylinder, and a rear-surface printing unit having a second impression cylinder that can carry the cut paper by rotating while holding the cut paper, a second blanket cylinder that contacts the second impression cylinder and can transfer heatset ink onto a rear surface of the cut paper, and a second ink jet head that can supply the heatset ink to the second blanket cylinder, in which the first impression cylinder and the second impression cylinder directly contact each other.

### FIELD

The present invention relates to a sheet-fed duplex printing press that performs duplex printing on cut paper using ink jet heads.

### BACKGROUND

For example, Patent Literature 1 describes an offset sheet-fed duplex printing press that performs duplex printing. The sheet-fed duplex printing press described in Patent Literature 1 has a front-surface printing unit arranged behind a rear-surface printing unit, and first performs rear-surface printing starting from a lower part of carried cut paper using the rear-surface printing unit and then performs front-surface printing starting from an upper part of the cut paper using the front-surface printing unit. This type of printing press grips an end of the cut paper with a gripper nail device, thereby providing high-accuracy carriage and high-speed print of about 250 sheets per minute even for large cut paper no smaller than an A2 size and no larger than a quadruple A (four times as large as an A1 size), for example. A printing press described in Patent Literature 2 is a simple office printing press that sends cut paper while nipping the cut paper with rubber rollers and thus the cut paper is an A3 size or smaller. Accordingly, the print speed cannot be increased to higher than a rate of about 100 sheets per minute and also high-accuracy duplex printing cannot be performed.

On the other hand, Patent Literature 3 describes an example of a printing press that performs printing using ink jet heads. The sheet-fed printing press described in Patent Literature 2 uses a plurality of ink jet heads as drawing units and performs printing by directly spraying ink to cut paper from thereabove.

### CITATION LIST

### Patent Literatures

Patent Literature 1: Japanese Patent Application Laid-open No. 2003-039628
Patent Literature 2: Japanese Patent Application Laid-open No. 08-337011
Patent Literature 3: Japanese Patent Application Laid-open No. 2009-096175

### SUMMARY

### Technical Problem

The sheet-fed printing press using the ink jet heads as described in Patent Literature 3 is more advantageous in terms of costs than the sheet-fed printing press using a press plate as described in Patent Literature 1 when few matters are to be printed. Because the sheet-fed printing press as described in Patent Literature 3 is of a cylinder type, the size of cut paper is A2 or larger and the print speed can be increased; however, this is a single-side printing press and cannot perform duplex printing.

In this case, it may be considered that the sheet-fed single-side printing press described in Patent Literature 2 is arranged as the sheet-fed duplex printing press described in Patent Literature 1. However, when the rear-surface printing is performed in this case, the ink jet heads spray ink upward against gravity, which brings high-accuracy drawing on cut paper into difficulty.

The present invention has been achieved to solve these problems and an object of the present invention is to provide a sheet-fed duplex printing press that can perform high-accuracy duplex printing.

### Solution to Problem

According to an aspect of the present invention, a sheet-fed duplex printing press that performs duplex printing by supplying ink to a first surface of cut paper and a second surface on an opposite side thereof from the first surface, includes: a first printing cylinder that can carry the cut paper by rotating while holding the cut paper; a first transfer body that contacts the first printing cylinder and can transfer ink onto the first surface of the cut paper; a first ink jet head that can supply the ink to the first transfer body; a second printing cylinder that contacts the first printing cylinder directly or via an intermediate cylinder and can carry the cut paper by rotating while holding the cut paper; a second transfer body that contacts the second printing cylinder and can transfer ink to the second surface of the cut paper; and a second ink jet head that can supply the ink to the second transfer body.

Therefore, the ink is supplied by being transferred from the transfer bodies onto the cut paper held by the printing cylinders, the first and second ink jet heads can be located at appropriate positions with respect to corresponding transfer cylinders, and high-accuracy duplex printing can be achieved.

Advantageously, in the sheet-fed duplex printing press, the first and second ink jet heads are located over the first and second transfer bodies, respectively.

Therefore, high-accuracy duplex printing can be achieved by locating the first and second ink jet heads over the corresponding transfer cylinders.

Advantageously, in the sheet-fed duplex printing press, the first printing cylinder and the second printing cylinder are located at positions vertically shifted from each other.

Therefore, placement spaces for the first and second ink jet heads are created and compact placement is realized by locating the first printing cylinder and the second printing cylinder at positions vertically shifted from each other.

Advantageously, in the sheet-fed duplex printing press, the first and second printing cylinders have a circumference that is set to an integral multiplex of that of the first and second transfer bodies.

Therefore, by setting the circumference of the printing cylinders to an integral multiplex of that of the transfer bodies, spaces around the printing cylinders are increased and placement spaces to install the ink jet heads, four ink jet heads of C (cyan), M (magenta), Y (yellow), and K (black) in the case of color printing, for example, and drying devices, and cleaning rollers as well as the transfer bodies are created, thereby realizing compact placement.

Advantageously, the sheet-fed duplex printing press further includes first and second drying devices that primarily dry the ink supplied to the first and second transfer bodies, respectively.

Therefore, ink of images formed by the ink jet heads on surfaces of the transfer bodies is primarily dried by the drying devices and then transferred onto the cut paper, so that that the ink is transferred from the transfer bodies to the cut paper in a higher-viscosity state and accordingly the ink does not penetrate into the cut paper, thereby enhancing printing accuracy.

Advantageously, the sheet-fed duplex printing press further includes third and fourth drying devices that secondarily dry the ink transferred from the first and second transfer bodies onto the cut paper, respectively.

Therefore, the ink on the cut paper primarily dried by the drying devices is secondarily dried by the third and fourth drying devices, which securely dries the ink to prevent damages of print surfaces due to contact between sheets of the cut paper.

Advantageously, in the sheet-fed duplex printing press, the first and second ink jet heads can supply heatset ink to peripheral surfaces of the first and second transfer bodies, and the first to fourth drying devices are first to fourth heating devices, respectively.

Therefore, by using the heatset ink, the drying time of the ink can be reduced and damages of print surfaces due to contact between sheets of the cut paper can be prevented.

Advantageously, in the sheet-fed duplex printing press, the first and second heating devices are located on opposite sides of the first and second transfer bodies from the first and second ink jet heads, respectively.

Therefore, effects of thermal energy of the heating devices on the ink sprayed from the ink jet heads are suppressed, which prevents clogging of ink jet nozzles and enables high-accuracy image formation by the spray of the ink.

### Advantageous Effects of Invention

According to the sheet-fed duplex printing press of the present invention, the second printing cylinder, the first and second transfer bodies that can transfer ink onto cut paper on the printing cylinder, and the first and second ink jet heads that can supply ink to the transfer bodies, respectively, are included, and the first printing cylinder and the second printing cylinder are arranged to contact each other directly or via an intermediate cylinder. Therefore, high-accuracy duplex printing can be achieved.

### BRIEF DESCRIPTION OF DRAWINGS

FIG. 1 is a schematic configuration diagram of an offset sheet-fed duplex printing press according to a first embodiment of the present invention.

FIG. 2 is a schematic configuration diagram of an offset sheet-fed duplex printing press according to a second embodiment of the present invention.

FIG. 3 is a schematic configuration diagram of an offset sheet-fed duplex printing press according to a third embodiment of the present invention.

FIG. 4 is a schematic configuration diagram of an offset sheet-fed duplex printing press according to a fourth embodiment of the present invention.

FIG. 5 is a schematic configuration diagram of an offset sheet-fed duplex printing press according to a fifth embodiment of the present invention.

FIG. 6 is a schematic configuration diagram of an offset sheet-fed duplex printing press according to a sixth embodiment of the present invention.

FIG. 7 is a schematic configuration diagram of an offset sheet-fed duplex printing press according to a seventh embodiment of the present invention.

FIG. 8 is a schematic configuration diagram of an offset sheet-fed duplex printing press according to an eighth embodiment of the present invention.

FIG. 9 is a schematic configuration diagram of a sheet-fed duplex printing press according to a ninth embodiment of the present invention.

### DESCRIPTION OF EMBODIMENTS

Exemplary embodiments of a sheet-fed duplex printing press according to the present invention will be explained below in detail with reference to the accompanying drawings. The present invention is not limited to the embodiments.

### First Embodiment

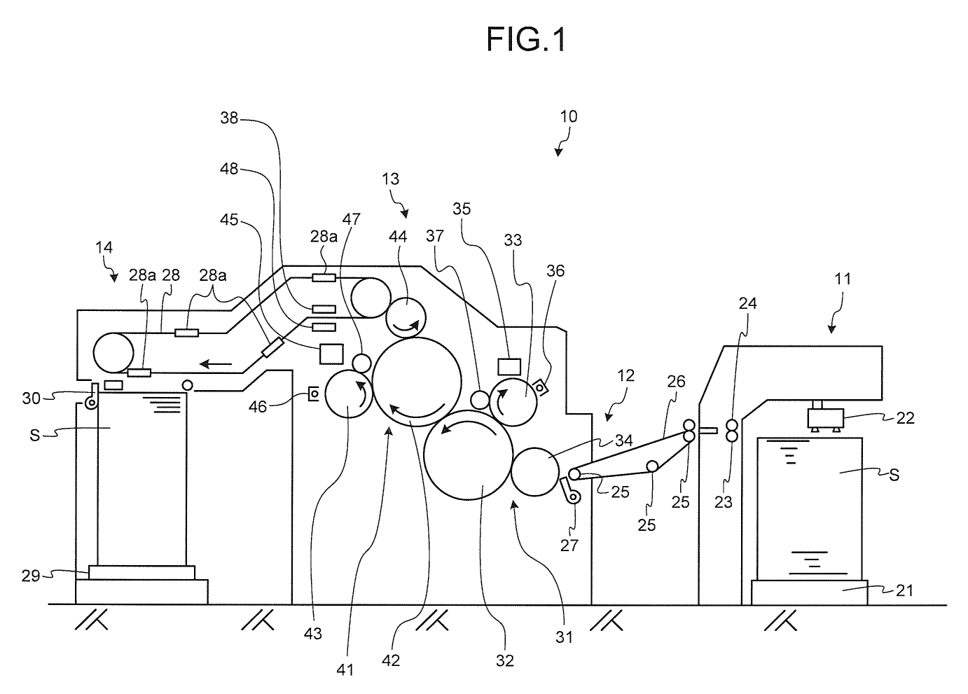

FIG. 1 is a schematic configuration diagram of an offset sheet-fed duplex printing press according to a first embodiment of the present invention.

In the first embodiment, an offset sheet-fed duplex printing press 10 as a sheet-fed duplex printing press includes a feeder device 11, a carrying device 12, a printing device 13, and a delivery device 14 as shown in FIG. 1.

The feeder device 11 has a feeder board 21 and a separator device 22 serving as a feeding mechanism. The feeder board 21 has sheets of cut paper S placed thereon, being stacked one above another, and the separator device 22 picks the many sheets of cut paper S stacked on the feeder board 21 one by one from the top to send the picked sheets. In this case, the feeder board 21 can vertically move with supply of the cut paper S to enable the separator device 22 to keep a substantially uniform positional relation in height with the cut paper S.

The carrying device 12 carries the cut paper S sent from the feeder device 11 to place the cut paper S at a predetermined position and supplies the cut paper S to the printing device 13. In the carrying device 12, a feed roller 23 and a grip roller 24 are arranged to vertically contact each other adjacent to the feeder device 11, a carrying belt 26 is hung across a plurality of guide rollers 25, and a front lay 27 is located adjacent to the printing device 13.

The printing device 13 represents a sheet-fed duplex printing press according to the present invention, and includes a front-surface printing unit 31 that prints on a front surface which is a first surface of the cut paper S and a rear-surface printing unit 41 that prints on a rear surface which is a second surface on an opposite side of the cut paper S from the first surface. In this case, with respect to the front-surface printing unit 31, the rear-surface printing unit 41 is located downstream, that is, on a side of the delivery device 14 and on an upper side in the vertical direction.

The front-surface printing unit 31 has a first impression cylinder 32 as a first printing cylinder and a first blanket cylinder 33 as a first transfer cylinder (first transfer body). With respect to the first impression cylinder 32, the first blanket cylinder 33 is located above and upstream, that is, on a side of the feeder device 11, and the first impression cylinder 32 and the first blanket cylinder 33 are rotatably supported to contact each other. The first impression cylinder 32 contacts an intermediate cylinder 34 that is rotatably placed adjacent to the front lay 27. In this case, a circumference of the first impression cylinder 32 is set to an integral multiple, double in the present embodiment, of that of the first blanket cylinder 33 and the intermediate cylinder 34.

The first impression cylinder 32, the first blanket cylinder 33, and the intermediate cylinder 34 are coupled with gears to synchronously rotate in directions of arrows in FIG. 1 and can be rotated by one motor (not shown). In this case, a blanket that has a surface formed of silicon is wrapped around the first blanket cylinder 33 in consideration of release of printed images. The first impression cylinder 32 and the intermediate cylinder 34 each have a gripper nail (not shown). The gripper nail of the intermediate cylinder 34 grabs an end (front end in a carrying direction) of the cut paper S positioned at the front lay 27 of the carrying device 12 to carry the cut paper S and then the gripper nail of the first impression cylinder 32 grabs the end of the cut paper S released from the gripper nail of the intermediate cylinder 34 to carry the cut paper S.

Near an outer side of the first blanket cylinder 33, a first ink jet head 35 is provided to spray heatset ink (ink thermosetting ink, that is, water-based or oil-based ink including thermoplastic resin) onto a surface of the first blanket cylinder 33 to form an image. The first ink jet head 35 is located over the first blanket cylinder 33 and has a plurality of nozzles (not shown) arranged in an axial direction of the first blanket cylinder 33, that is, in a width direction of the cut paper S to enable the heatset ink to be sprayed over an entire area of the cut paper S in the width direction.

Near the outer side of the first blanket cylinder 33, a first heat lamp 36 as a first heating device (first drying device) is also provided on a side downstream of the first ink jet head 35 in a rotation direction of the first blanket cylinder 33 and upstream of a position where the first impression cylinder 32 and the first blanket cylinder 33 contact in the rotation direction of the first blanket cylinder 33. The first heat lamp 36 primarily heats the image of the ink sprayed on the outer peripheral surface of the first blanket cylinder 33 from the first ink jet head 35 to semi-dry the image. In this case, the first heat lamp 36 is a halogen lamp or an infrared lamp, and is a UV (ultraviolet) lamp or a light-emitting diode UV (LED-UV) lamp when the heatset ink is ultraviolet curing ink. An output thereof is set to 10 to 30% of an output of that completely dries the image of the heatset ink sprayed by the first ink jet head 35.

Near the outer side of the first blanket cylinder 33, a first cleaning roller 37 as a cleaning device is also provided on a side downstream of the contact position with the first impression cylinder 32 in the rotation direction of the first blanket cylinder 33 and upstream of the first ink jet head 35 in the rotation direction of the first blanket cylinder 33. The first cleaning roller 37 removes ink remaining on the surface of the first blanket cylinder 33 after the image formed on the surface of the first blanket cylinder 33 is transferred onto the cut paper S to clean the surface. The first cleaning roller 37 simultaneously rotates with the first blanket cylinder 33 or is driven and rotated in the opposite direction to the first blanket cylinder 33, thereby removing the heatset ink remaining on the surface of the first blanket cylinder 33.

The rear-surface printing unit 41 has almost the same configuration as that of the front-surface printing unit 31, and includes a second impression cylinder 42 as a second printing cylinder and a second blanket cylinder 43 as a second transfer cylinder (second transfer body). The second blanket cylinder 43 is located on an upper side of the second impression cylinder 42 and the cylinders 42 and 43 are rotatably supported to contact each other. In this case, a circumference of the second impression cylinder 42 is set to an integral multiple, double in the present embodiment, of that of the second blanket cylinder 43 and an intermediate cylinder 44.

The second impression cylinder 42 and the second blanket cylinder 43 are coupled with gears to synchronously rotate in directions of arrows in FIG. 1 and can be rotated by one motor (not shown). The second impression cylinder 42 is located downstream of the first impression cylinder 32, that is, on a side of the delivery device 14 and on an upper side of the first impression cylinder 32 in the vertical direction, and the second impression cylinder 42 and the second blanket cylinder 43 can synchronously rotate also with the first impression cylinder 32 and the first blanket cylinder 33. In this case, a blanket that has a surface formed of silicon is wrapped around the second blanket cylinder 43 in consideration of release of printed images. The second impression cylinder 42 has a gripper nail (not shown) and the gripper nail of the second impression cylinder 42 grabs the end of the cut paper S released from the gripper nail of the first impression cylinder 32 to carry the cut paper S.

Near an outer side of the second blanket cylinder 43, a second ink jet head 45 is provided to spray heatset ink (ink thermosetting ink, that is, water-based or oil-based ink including thermoplastic resin) onto a surface of the second blanket cylinder 43 to form an image. The second ink jet head 45 is located over the second blanket cylinder 43 and has a plurality of nozzles (not shown) arranged in an axial direction of the second blanket cylinder 43, that is, in the width direction of the cut paper S to enable the heatset ink to be sprayed over an entire area of the cut paper S in the width direction.

Near the outer side of the second blanket cylinder 43, a second heat lamp 46 as a second heating device (second drying device) is also provided on a side downstream of the second ink jet head 45 in a rotation direction of the second blanket cylinder 43 and upstream of a contact position between the second impression cylinder 42 and the second blanket cylinder 43 in the rotation direction of the second blanket cylinder 43. The second heat lamp 46 primarily heats the image of the ink sprayed from the second ink jet head 45 to the outer peripheral surface of the second blanket cylinder 43 to semi-dry the image. In this case, the second heat lamp 46 is a halogen lamp or an infrared lamp, and is a UV (ultraviolet) lamp or an LED-UV lamp when the heatset ink is ultraviolet curing ink. An output thereof is set to 10 to 30% of an output of that completely dries the image of the heatset ink sprayed by the second ink jet head 45.

Near the outer side of the second blanket cylinder 43, a second cleaning roller 47 as a cleaning device is also provided on a side downstream of the contact position with the second impression cylinder 42 in the rotation direction of the second blanket cylinder 43 and upstream of the second ink jet head 45 in the rotation direction of the second blanket cylinder 43. The second cleaning roller 47 removes ink remaining on the surface of the second blanket cylinder 43 after the image formed on the surface of the second blanket cylinder 43 is transferred onto the cut paper S to clean the surface. The second cleaning roller 47 simultaneously rotates with the second blanket cylinder 43 or is driven and rotated in the opposite direction to the second blanket cylinder 43, thereby removing the heatset ink remaining on the surface of the second blanket cylinder 43.

The delivery device 14 carries the cut paper S printed by the printing device 13 and stacks the cut paper S one above another in an aligned state. The delivery device 14 has a chain gripper 28 that carries the cut paper S, a delivery pile board 29 on which the printed cut paper S is stacked, and a paper lay 30 that aligns the cut paper S. The intermediate cylinder 44 is located between the second impression cylinder 42 of the rear-surface printing unit 41 and the chain gripper 28.

In this case, the gripper nail of the second impression cylinder 42 grabs the end of the cut paper S to carry the cut paper S and a gripper nail (not shown) of the intermediate cylinder 44 grabs the end of the cut paper S released from the gripper nail of the second impression cylinder 42 to carry the cut paper S. The chain gripper 28 has a plurality of gripper nails 28a that grip the end of the cut paper S, and receives the cut paper S from the second impression cylinder 42 via the intermediate cylinder 44 to carry the cut paper S to a predetermined position over the delivery pile board 29. The delivery pile board 29 can descend in a continuous or stepwise fashion so that a drop distance of the cut paper S becomes substantially uniform when the height of an upper surface of a top cut paper increases as the cut paper S is stacked. The paper lay 30 restricts a position of the end of the cut paper S in a moving direction.

The delivery device 14 has third and fourth heat lamps 38 and 48 located over and under the cut paper S carried by the chain gripper 28 as third and fourth heating devices (third and fourth drying devices), respectively. The third and fourth heat lamps 38 and 48 secondarily heat the images of the ink transferred from the first and second blanket cylinders 33 and 43 onto the front and rear surfaces of the cut paper S to totally dry the images, respectively. In this case, the third and fourth heat lamps 38 and 48 are halogen lamps, infrared lamps, UV (ultraviolet) lamps, or LED-UV lamps, and outputs thereof are set to 70 to 90% of an output of that completely dries the images of the heatset ink transferred onto the cut paper S.

A printing method performed by the offset sheet-fed duplex printing press 10 according to the first embodiment configured as mentioned above is explained.

The sheets of the cut paper S stacked on the feeder board 21 of the feeder device 11 are picked one by one from the top by the separator device 22 and are sent to the carrying device 12. The carrying device 12 positions the cut paper S with the front lay 27 and then supplies the cut paper S one after another to the printing device 13.

In the front-surface printing unit 31 of the printing device 13, the first ink jet head 35 sprays heatset ink through the nozzles toward the first blanket cylinder 33, thereby forming a predetermined image on the surface of the first blanket cylinder 33. The image moved with rotation of the first blanket cylinder 33 is primarily dried, that is, semi-dried by light and heat from the first heat lamp 36. Meanwhile, the intermediate cylinder 34 receives the cut paper S sent from the carrying device 12 and transfers the cut paper S to the first impression cylinder 32. When the cut paper S is carried to the first impression cylinder 32 and passes between the first impression cylinder 32 and the first blanket cylinder 33 with being pressurized, the image on the first blanket cylinder 33 is transferred onto the front surface of the cut paper S. The first blanket cylinder 33 from which the image has been transferred onto the cut paper S is in contact with the first cleaning roller 37, which removes the heatset ink remaining on the surface.

In the rear-surface printing unit 41 of the printing device 13, the second ink jet head 45 sprays heatset ink through the nozzles toward the second blanket cylinder 43, thereby forming a predetermined image on the surface of the second blanket cylinder 43. The image moved with rotation of the second blanket cylinder 43 is primarily dried, that is, semi-dried by light and heat from the second heat lamp 46. Meanwhile, the first impression cylinder 32 transfers the cut paper S having the front surface subjected to printing to the second impression cylinder 42. When the cut paper S is carried to the second impression cylinder 42 and passes between the second impression cylinder 42 and the second blanket cylinder 43 with being pressurized, the image on the second blanket cylinder 43 is transferred onto the rear surface of the cut paper S. The second blanket cylinder 43 from which the image has been transferred onto the cut paper S is in contact with the second cleaning roller 47, which removes the heatset ink remaining on the surface.

The cut paper S having the front and rear surfaces subjected to printing is transferred from the second impression cylinder 42 of the printing device 13 to the intermediate cylinder 44 and is sent to the delivery device 14. In the delivery device 14, the chain gripper 28 carries the cut paper S while gripping the end thereof. At this time, the images on the front and rear surfaces of the cut paper S being carried are secondarily dried, that is, fully dried by light and heat from the third and fourth heat lamps 38 and 48.

Drying and generation of the images (heatset ink) are explained. The ink that is sprayed from the ink jet heads 35 and 45 to the surfaces of the corresponding blanket cylinders 33 and 43 to form images on the surfaces of the blanket cylinders 33 and 43 is in a low-viscosity state, respectively. The ink of the images in the low-viscosity state moved with rotation of the blanket cylinders 33 and 43 becomes ink in a semi-dried state due to the light and heat from the heat lamps 36 and 46, respectively. The ink of the image in the semi-dried state moved with further rotation of the blanket cylinder 33 or 43 is transferred onto the front or rear surface of the cut paper S by an effect of a predetermined nip between the corresponding blanket cylinder 33 or 43 and the cut paper S carried by the corresponding impression cylinder 32 or 42. When the cut paper S moves with rotation of the corresponding impression cylinder 32 or 42, the ink of the image in the semi-dried state moved together with the cut paper S becomes ink in a completely dried state due to the light and heat from the corresponding heat lamp 38 or 48.

At this time, the images of the heatset ink sprayed from the ink jet heads 35 and 45 onto the surfaces of the blanket cylinders 33 and 43 have higher ink viscosity particularly on the surfaces because the light and heat is applied from the heat lamps 36 and 46 to the surfaces, respectively. The images of the semi-dried ink are transferred in such a manner that the surfaces of the images with the higher viscosity are tightly adhered to the cut paper S on the impression cylinders 32 and 42. The images of the ink have higher release from the blanket cylinders 33 and 43 and higher adhesion to the cut paper S. The images of the semi-dried ink transferred onto the front and rear surfaces of the cut paper S have lower viscosity on the surfaces, and then the heat lamps 38 and 48 totally dries the images of the ink on the cut paper S by applying light and heat thereto until the ink is cured.

The cut paper S having the ink completely dried on the front and rear surfaces is then carried by the chain gripper 28 and stacked on the delivery pile board 29.

As described above, the offset sheet-fed duplex printing press according to the first embodiment includes the front-surface printing unit 31 having the first impression cylinder 32 that can carry the cut paper S by rotating while holding the cut paper S, the first blanket cylinder 33 that contacts the first impression cylinder 32 and can transfer heatset ink onto the front surface of the cut paper S, and the first ink jet head 35 that can supply the heatset ink to the first blanket cylinder 33, and the rear-surface printing unit 41 having the second impression cylinder 42 that can carry the cut paper S by rotating while holding the cut paper S, the second blanket cylinder 43 that contacts the second impression cylinder 42 and can transfer heatset ink onto the rear surface of the cut paper S, and the second ink jet head 45 that can supply the heatset ink to the second blanket cylinder 43, in which the first impression cylinder 32 and the second impression cylinder 42 directly contact each other.

Therefore, in the printing units 31 and 41, the heatset ink is supplied by being transferred from the blanket cylinders 33 and 43 onto the front and rear surfaces of the cut paper S held by the impression cylinders 32 and 42, which enables the first and second ink jet heads 35 and 45 to be located at appropriate positions with respect to the first and second blanket cylinders 33 and 43, that is, over the first and second blanket cylinders 33 and 43, respectively. Accordingly, the ink jet heads 35 and 45 can spray the heatset ink downward, which is the same direction as the gravity, and can form high-accuracy images on the surfaces of the blanket cylinders 33 and 43, respectively. As a result, high-accuracy duplex printing can be achieved.

In the offset sheet-fed duplex printing press according to the first embodiment, the first impression cylinder 32 of the front-surface printing unit 31 and the second impression cylinder 42 of the rear-surface printing unit 41 are located at positions vertically shifted from each other. Therefore, spaces are created around the first impression cylinder 32 and the second impression cylinder 42, thereby securing placement spaces for the first and second ink jet heads 35 and 45 and enabling compact placement. Because the first impression cylinder 32 of the front-surface printing unit 31 and the second impression cylinder 42 of the rear-surface printing unit 41 are located at positions vertically shifted from each other, entire height and length of the machine can be suppressed and a compact machine can be realized.

In the offset sheet-fed duplex printing press according to the first embodiment, the circumference of the first and second impression cylinders 32 and 42 is set double as long as that of the first and second blanket cylinders 33 and 43. Therefore, the blanket cylinders 33 and 43, the ink jet heads 35 and 45, the heat lamps 36 and 46, and the like can be arranged compactly.

In the offset sheet-fed duplex printing press according to the first embodiment, the first and second heat lamps 36 and 46 that primarily dry the heatset ink supplied to the first and second blanket cylinders 33 and 43, respectively, are included and the third and fourth heat lamps 38 and 48 that secondarily dry the heatset ink transferred from the first and second blanket cylinders 33 and 43 onto the cut paper S, respectively, are also included. Therefore, the ink of the images formed on the surfaces of the blanket cylinders 33 and 43 by the ink jet heads 35 and 45 is transferred onto the cut paper S after being primarily dried by the head lamps 36 and 46, respectively. Accordingly, the ink is transferred in a higher-viscosity state, which prevents the ink from penetrating into the cut paper S and enhances printing accuracy. The ink on the cut paper S primarily dried by the first and second heat lamps 36 and 46 is secondarily dried by the third and fourth heat lamps 38 and 48, respectively, to surely dry the ink, which prevents damages on print surfaces due to contact between sheets of the cut paper S.

In the offset sheet-fed duplex printing press according to the first embodiment, the ink used by the first and second ink jet heads 35 and 45 is heatset ink and can be dried by the heat lamps 36, 46, 38, and 48. Accordingly, by using the heatset ink, the drying time of the ink is reduced and damages of the print surfaces due to contact between the sheets of the cut paper S can be prevented.

### Second Embodiment

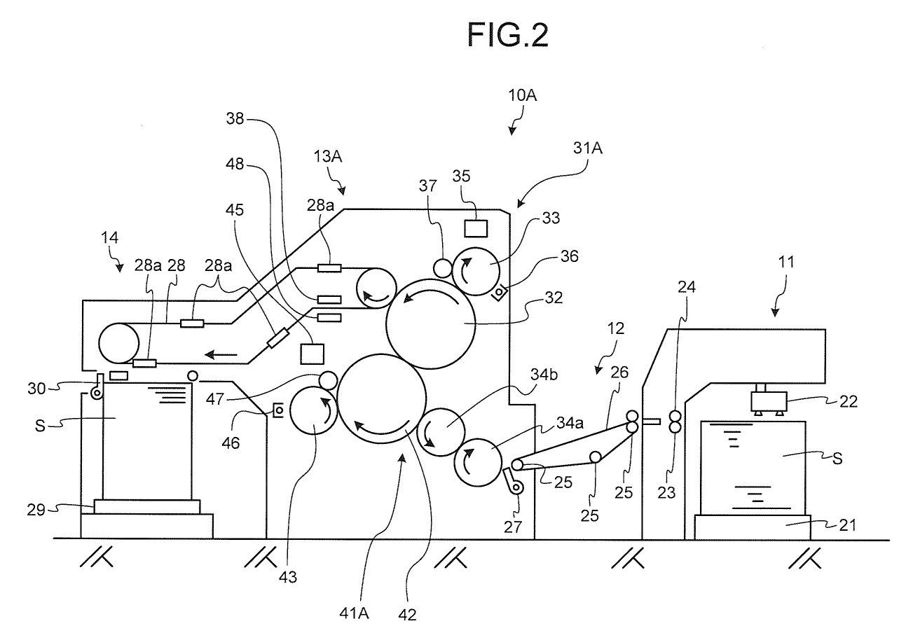

FIG. 2 is a schematic configuration diagram of an offset sheet-fed duplex printing press according to a second embodiment of the present invention. Members having functions identical to those described in the above embodiment are denoted by like reference signs and detailed explanations thereof will be omitted.

In the second embodiment, an offset sheet-fed duplex printing press 10A as a sheet-fed duplex printing press includes the feeder device 11, the carrying device 12, a printing device 13A, and the delivery device 14 as shown in FIG. 2. Because the feeder device 11, the carrying device 12, and the delivery device 14 according to the second embodiment are identical to those according to the first embodiment described above, explanations thereof will be omitted.

The printing device 13A represents a sheet-fed duplex printing press according to the present invention, and includes a front-surface printing unit 31A that prints on the front surface which is the first surface of the cut paper S and a rear-surface printing unit 41A that prints on the rear surface which is the second surface on the opposite side of the cut paper S from the first surface. In this case, the front-surface printing unit 31A is located downstream of the rear-surface printing unit 41A, and is located on an upper side thereof in the vertical direction and on a side of the feeder device 11.

The rear-surface printing unit 41A has the second impression cylinder 42 and the second blanket cylinder 43. The second blanket cylinder 43 is located rearward (on a side of the delivery device 14) of the second impression cylinder 42, and the cylinders 42 and 43 are rotatably supported to contact each other. The second impression cylinder 42 is connected to the carrying device 12 via two intermediate cylinders 34a and 34b, and receives the cut paper S from the intermediate cylinder 34b. The second ink jet head 45, the second heat lamp 46, and the second cleaning roller 47 are provided near the outer side of the second blanket cylinder 43.

The front-surface printing unit 31A has the first impression cylinder 32 and the first blanket cylinder 33.

The first blanket cylinder 33 is located forward (on a side of the feeder device 11) of the first impression cylinder 32, and the cylinders 32 and 33 are rotatably supported to contact each other. The first impression cylinder 32 directly contacts the second impression cylinder 42, is connected to the chain gripper 28 of the delivery device 14, receives the cut paper S from the second impression cylinder 42, and transfers the cut paper S to the chain gripper 28. The first ink jet head 35, the first heat lamp 36, and the first cleaning roller 37 are provided near the outer side of the first blanket cylinder 33.

Therefore, the cut paper S is fed from the feeder device 11 to the printing device 13A via the carrying device 12. In the rear-surface printing unit 41A, the second ink jet head 45 sprays heatset ink to the second blanket cylinder 43, thereby forming a predetermined image on the surface thereof, and then the image is primarily dried, that is, semi-dried by the light and heat from the second heat lamp 46. The cut paper S is carried to the second impression cylinder 42 and, when the cut paper S passes between the second impression cylinder 42 and the second blanket cylinder 43 with being pressurized, the image on the second blanket cylinder 43 is transferred onto the rear surface of the cut paper S.

In the front-surface printing unit 31A, the first ink jet head 35 sprays heatset ink to the first blanket cylinder 33, thereby forming a predetermined image on the surface thereof, and then the image is primarily dried, that is, semi-dried by the light and heat from the first heat lamp 36. The cut paper S is carried from the second impression cylinder 42 to the first impression cylinder 32 and, when the cut paper S passes between the first impression cylinder 32 and the first blanket cylinder 33 with being pressurized, the image on the first blanket cylinder 33 is transferred onto the front surface of the cut paper S.

The cut paper S having the front and rear surfaces subjected to printing is then sent from the first impression cylinder 32 of the printing device 13A to the delivery device 14. In the delivery device 14, the chain gripper 28 carries the cut paper S while gripping an end thereof and, at this time, the images on the front and rear surfaces of the cut paper S being carried are secondarily dried, that is, fully dried by the light and heat from the third and fourth heat lamps 38 and 48. The cut paper S having the front and rear surfaces with the ink completely dried is then stacked on the delivery pile board 29 by the chain gripper 28.

As described above, in the offset sheet-fed duplex printing press according to the second embodiment, the rear-surface printing unit 41A and the front-surface printing unit 31A are arranged in the carrying direction of the cut paper S in the printing device 13A, and the front-surface printing unit 31A is located above the rear-surface printing unit 41A and on the side of the feeder device 11.

Therefore, the cut paper S is subjected printing on the rear surface and the front surface in this order, and the entire length of the printing press can be reduced by arranging the front-surface printing unit 31A above the rear-surface printing unit 41A and on the side of the feeder device 11. With this arrangement, the ink jet heads 35 and 45 can spray the heatset ink downward, which is the same direction as the gravity, and can form high-accuracy images on the surfaces of the blanket cylinders 33 and 43, respectively. As a result, high-accuracy duplex printing can be achieved.

### Third Embodiment

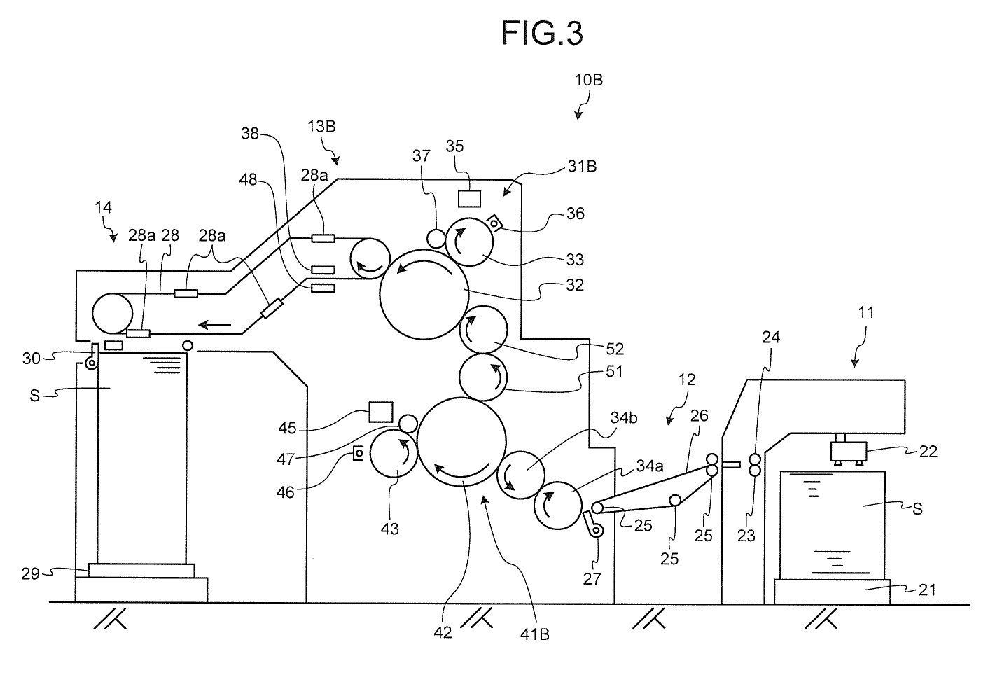

FIG. 3 is a schematic configuration diagram of an offset sheet-fed duplex printing press according to a third embodiment of the present invention. Members having functions identical to those described in the above embodiments are denoted by like reference signs and detailed explanations thereof will be omitted.

In the third embodiment, an offset sheet-fed duplex printing press 10B as a sheet-fed duplex printing press includes the feeder device 11, the carrying device 12, a printing device 13B, and the delivery device 14 as shown in FIG. 3. Because the feeder device 11, the carrying device 12, and the delivery device 14 according to the third embodiment are identical to those according to the first embodiment described above, explanations thereof will be omitted.

The printing device 13B represents a sheet-fed duplex printing press according to the present invention, and includes a front-surface printing unit 31B that prints on the front surface which is the first surface of the cut paper S and a rear-surface printing unit 41B that prints on the rear surface which is the second surface on the opposite side of the cut paper S from the first surface. In this case, the front-surface printing unit 31B is located downstream of the rear-surface printing unit 41B, and is located on an upper side thereof in the vertical direction and on a side of the feeder device 11.

The rear-surface printing unit 41B has the second impression cylinder 42 and the second blanket cylinder 43. The second impression cylinder 42 contacts the intermediate cylinder 34b, and the second ink jet head 45, the second heat lamp 46, and the second cleaning roller 47 are provided near the outer side of the second blanket cylinder 43. The front-surface printing unit 31B has the first impression cylinder 32 and the first blanket cylinder 33 and is connected to the chain gripper 28 of the delivery device 14. The first ink jet head 35, the first heat lamp 36, and the first cleaning roller 37 are provided near the outer side of the first blanket cylinder 33. The second impression cylinder 42 and the first impression cylinder 32 are arranged one above the other, and two intermediate cylinders 51 and 52 are arranged in series to contact each other between these impression cylinders 32 and 42. In this case, the second impression cylinder 42, the intermediate cylinder 51, the intermediate cylinder 52, and the first impression cylinder 32 are arranged substantially linearly in the vertical direction.

In a printing method performed by the offset sheet-fed duplex printing press 10B according to the third embodiment, when the cut paper S is carried from the rear-surface printing unit 41B to the front-surface printing unit 31B, the cut paper S is carried from the second impression cylinder 42 to the first impression cylinder 32 via the two intermediate cylinders 51 and 52. Other features in the third embodiment are almost the same as those in the second embodiment and thus explanations thereof will be omitted.

As described above, in the offset sheet-fed duplex printing press according to the third embodiment, the rear-surface printing unit 41B and the front-surface printing unit 31B are arranged in the carrying direction of the cut paper S in the printing device 13B, in which the front-surface printing unit 31B is located above the rear-surface printing unit 41B and on the side of the feeder device 11 and the two intermediate cylinders 51 and 52 are arranged in series between the second impression cylinder 42 and the first impression cylinder 32 that are arranged one above the other.

Therefore, the cut paper S is subjected to printing on the rear surface and the front surface in this order. By interposing the intermediate cylinders 51 and 52 between the front-surface printing unit 31B and the rear-surface printing unit 41B arranged one above the other, the entire length of the printing press can be reduced and spaces are created around the second impression cylinder 42 and the first impression cylinder 32, which facilitates arrangement of the blanket cylinders 33 and 43, the ink jet heads 35 and 45, the heat lamps 36 and 46, and the like. With this arrangement, the ink jet heads 35 and 45 can spray the heatset ink downward, which is the same direction as the gravity, and can form high-accuracy images on the surfaces of the blanket cylinders 33 and 43, respectively. As a result, high-accuracy duplex printing can be achieved.

### Fourth Embodiment

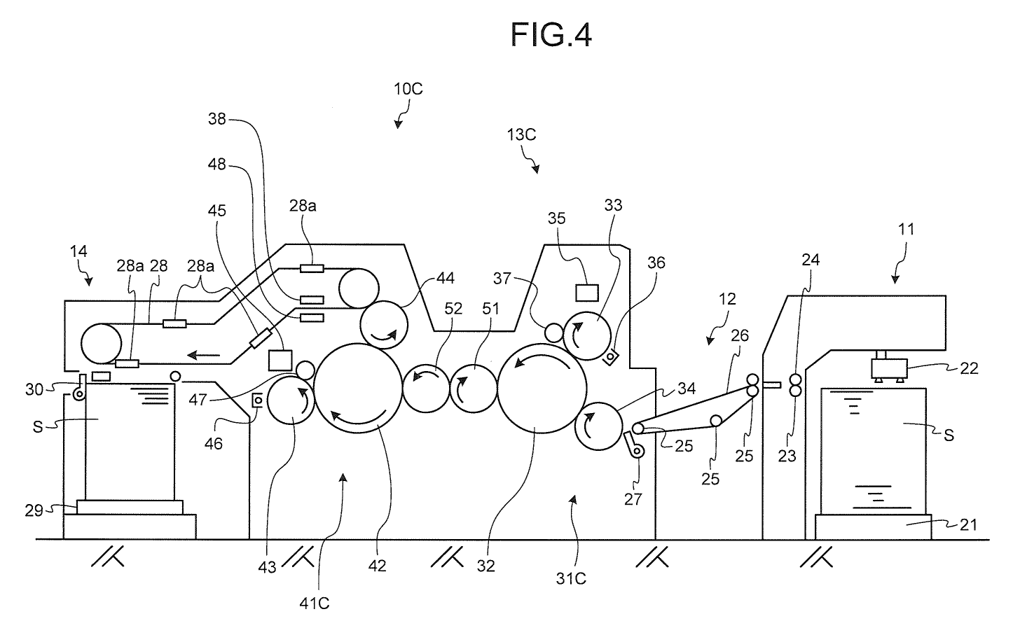

FIG. 4 is a schematic configuration diagram of an offset sheet-fed duplex printing press according to a fourth embodiment of the present invention. Members having functions identical to those described in the above embodiments are denoted by like reference signs and detailed explanations thereof will be omitted.

In the fourth embodiment, an offset sheet-fed duplex printing press 100 as a sheet-fed duplex printing press includes the feeder device 11, the carrying device 12, a printing device 13C, and the delivery device 14 as shown in FIG. 4. Because the feeder device 11, the carrying device 12, and the delivery device 14 according to the fourth embodiment are identical to those according to the first embodiment described above, explanations thereof will be omitted.

The printing device 13C represents a sheet-fed duplex printing press according to the present invention, and has a front-surface printing unit 31C that prints on the front surface which is the first surface of the cut paper S and a rear-surface printing unit 41C that prints on the rear surface which is the second surface on the opposite side of the cut paper S from the first surface. In this case, the front-surface printing unit 31C is located upstream of the rear-surface printing unit 41C and the printing units 31C and 41C are arranged in a substantially horizontal direction.

The front-surface printing unit 31C has the first impression cylinder 32 and the first blanket cylinder 33. The first impression cylinder 32 contacts the intermediate cylinder 34, and the first ink jet head 35, the first heat lamp 36, and the first cleaning roller 37 are provided near the outer side of the first blanket cylinder 33. The rear-surface printing unit 41C has the second impression cylinder 42 and the second blanket cylinder 43. The second impression cylinder 42 is connected to the chain gripper 28 of the delivery device 14 via the intermediate cylinder 44, and the second ink jet head 45, the second heat lamp 46, and the second cleaning roller 47 are provided near the outer side of the second blanket cylinder 43. The first impression cylinder 32 and the second impression cylinder 42 are arranged in an anteroposterior relation in the carrying direction of the cut paper S, and the two intermediate cylinders 51 and 52 are arranged in series therebetween to contact each other. In this case, the first impression cylinder 32, the intermediate cylinder 51, the intermediate cylinder 52, and the second impression cylinder 42 are arranged substantially linearly in the horizontal direction.

In a printing method performed by the offset sheet-fed duplex printing press 100 according to the fourth embodiment, when the cut paper S is carried from the front-surface printing unit 31C to the rear-surface printing unit 41C, the cut paper S is carried from the first impression cylinder 32 to the second impression cylinder 42 via the two intermediate cylinders 51 and 52. Other features in the fourth embodiment are almost the same as those in the first embodiment and thus explanations thereof will be omitted.

As described above, in the offset sheet-fed duplex printing press according to the fourth embodiment, the front-surface printing unit 31C and the rear-surface printing unit 41C are arranged in the carrying direction of the cut paper S in the printing device 13C, the front-surface printing unit 31C is located upstream of the rear-surface printing unit 41C, and the two intermediate cylinders 51 and 52 are arranged in series between the first impression cylinder 32 and the second impression cylinder 42.

Therefore, the cut paper S is subjected to printing on the front surface and the rear surface in this order. By interposing the intermediate cylinders 51 and 52 between the front-surface printing unit 31C and the rear-surface printing unit 41C horizontally arranged, the entire height of the printing press can be reduced and spaces can be created around the first impression cylinder 32 and the second impression cylinder 42, which facilitates arrangement of the blanket cylinders 33 and 43, the ink jet heads 35 and 45, the heat lamps 36 and 46, and the like. With this arrangement, the ink jet heads 35 and 45 can spray the heatset ink downward, which is the same direction as the gravity, and can form high-accuracy images on the surfaces of the blanket cylinders 33 and 43. As a result, high-accuracy duplex printing can be achieved.

### Fifth Embodiment

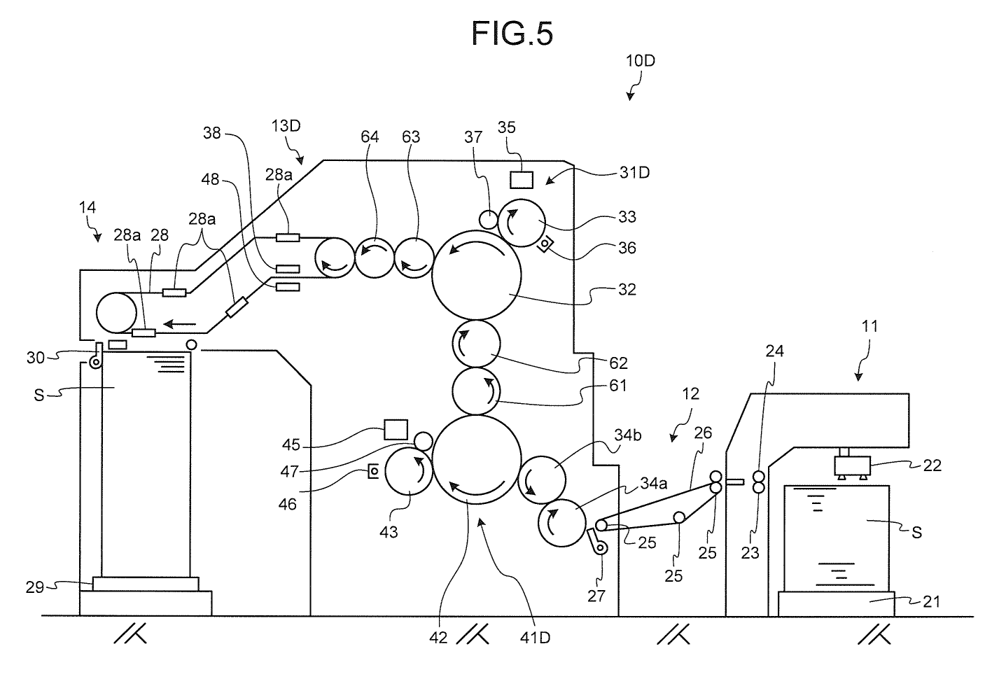

FIG. 5 is a schematic configuration diagram of an offset sheet-fed duplex printing press according to a fifth embodiment of the present invention. Members having functions identical to those described in the above embodiments are denoted by like reference signs and detailed explanations thereof will be omitted.

In the fifth embodiment, an offset sheet-fed duplex printing press 10D as a sheet-fed duplex printing press includes the feeder device 11, the carrying device 12, a printing device 13D, and the delivery device 14 as shown in FIG. 5. Because the feeder device 11, the carrying device 12, and the delivery device 14 according to the fifth embodiment are identical to those according to the first embodiment described above, explanations thereof will be omitted.

The printing device 13D represents a sheet-fed duplex printing press according to the present invention, and includes a front-surface printing unit 31D that prints on the front surface which is the first surface of the cut paper S and a rear-surface printing unit 41D that prints on the rear surface which is the second surface on the opposite side of the cut paper S from the first surface. In this case, the front-surface printing unit 31D is located downstream of the rear-surface printing unit 41D and on an upper side thereof in the vertical direction.

The rear-surface printing unit 41D has the second impression cylinder 42 and the second blanket cylinder 43. The second impression cylinder 42 contacts the intermediate cylinder 34b, and the second ink jet head 45, the second heat lamp 46, and the second cleaning roller 47 are provided near the outer side of the second blanket cylinder 43. The front-surface printing unit 31D has the first impression cylinder 32 and the first blanket cylinder 33, and the first ink jet head 35, the first heat lamp 36, and the first cleaning roller 37 are provided near the outer side of the first blanket cylinder 33.

The second impression cylinder 42 contacts a first press cylinder 61 downstream thereof, and the first press cylinder 61 contacts the first impression cylinder 32 via an intermediate cylinder 62. The first impression cylinder 32 contacts a second press cylinder 63 downstream thereof, and the second press cylinder 63 is connected to the chain gripper 28 of the delivery device 14 via an intermediate cylinder 64. In this case, the second impression cylinder 42, the first press cylinder 61, the intermediate cylinder 62, and the first impression cylinder 32 are arranged substantially linearly in the vertical direction, and the first impression cylinder 32, the second press cylinder 63, and the intermediate cylinder 64 are arranged substantially linearly in the horizontal direction. Each of the press cylinders 61 and 63 applies a pressure larger than a normal nip pressure to the ink (images) transferred onto the cut paper S with the corresponding impression cylinder 32 or 42, thereby smoothing the surface for glossing.

In a printing method performed by the offset sheet-fed duplex printing press 10D according to the fifth embodiment, the ink is transferred from the transfer cylinder 33 or 43 onto the cut paper S held by the impression cylinder 32 or 42 and then pressed by the press cylinder 61 or 63. Other features in the fifth embodiment are almost the same as those in the second embodiment and thus explanations thereof will be omitted.

As described above, in the offset sheet-fed duplex printing press according to the fifth embodiment, the rear-surface printing unit 41D and the front-surface printing unit 31D are arranged in the carrying direction of the cut paper S in the printing device 13D, the front-surface printing unit 31D is located above the rear-surface printing unit 41D, and the press cylinders 61 and 63 are located downstream of the impression cylinders 32 and 42.

Therefore, the cut paper S is subjected to printing on the rear surface and the front surface in this order, and by locating the press cylinders 61 and 63 downstream of the impression cylinders 32 and 42, smoothness and gloss of the printed images can be enhanced and high-accuracy duplex printing can be achieved.

### Sixth Embodiment

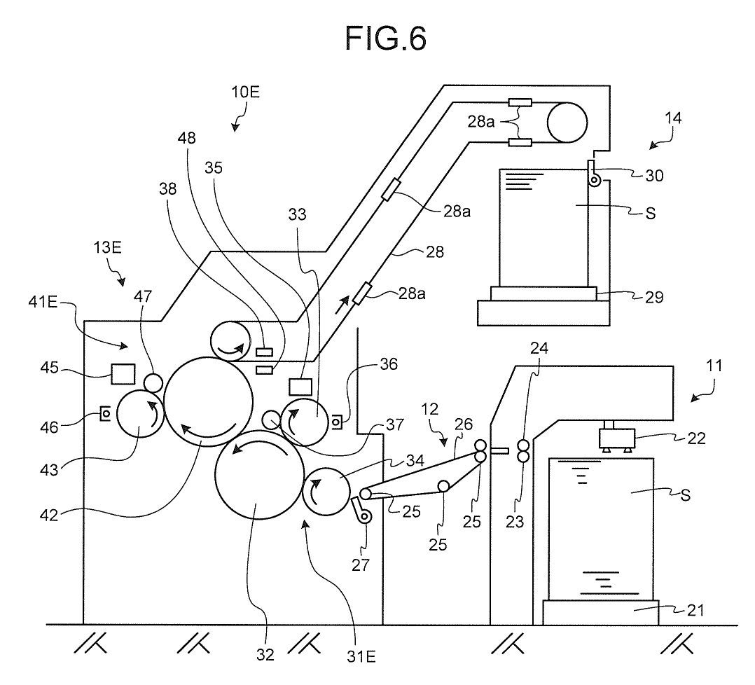

FIG. 6 is a schematic configuration diagram of an offset sheet-fed duplex printing press according to a sixth embodiment of the present invention. Members having functions identical to those described in the above embodiments are denoted by like reference signs and detailed explanations thereof will be omitted.

In the sixth embodiment, an offset sheet-fed duplex printing press 10E as a sheet-fed duplex printing press includes the feeder device 11, the carrying device 12, a printing device 13E, and the delivery device 14 as shown in FIG. 6. Because the feeder device 11, the carrying device 12, and the delivery device 14 according to the sixth embodiment are identical to those according to the first embodiment described above, explanations thereof will be omitted.

The printing device 13E represents a sheet-fed duplex printing press according to the present invention, and includes a front-surface printing unit 31E that prints on the front surface which is the first surface of the cut paper S and a rear-surface printing unit 41E that prints on the rear surface which is the second surface on the opposite side of the cut paper S from the first surface. In this case, the front-surface printing unit 31E is located upstream of the rear-surface printing unit 41E, and is located on a lower side thereof and on a side of the feeder device 11.

The front-surface printing unit 31E has the first impression cylinder 32 and the first blanket cylinder 33. The first impression cylinder 32 contacts the intermediate cylinder 34, and the first ink jet head 35, the first heat lamp 36, and the first cleaning roller 37 are provided near the outer side of the first blanket cylinder 33. The rear-surface printing unit 415 has the second impression cylinder 42 and the second blanket cylinder 43. The second impression cylinder 42 contacts the first impression cylinder 32 and is connected to the chain gripper 28 of the delivery device 14, and the second ink jet head 45, the second heat lamp 46, and the second cleaning roller 47 are provided near the outer side of the second blanket cylinder 43. In this case, the delivery device 14 is located above the feeder device 11, and the cut paper S printed by the rear-surface printing unit 415 is turned in an opposite direction to the feeding direction of the feeder device 11 and is carried to the delivery device 14 located above.

In a printing method performed by the offset sheet-fed duplex printing press 10E according to the sixth embodiment, the delivery device 14 is located above the feeder device 11, and other features in the sixth embodiment are almost the same as those in the first embodiment and thus explanations thereof will be omitted.

As described above, in the offset sheet-fed duplex printing press according to the sixth embodiment, the front-surface printing unit 31E and the rear-surface printing unit 41E are arranged in the carrying direction of the cut paper S in the printing device 13E and the delivery device 14 is located above the feeder device 11.

Therefore, the cut paper S is subjected to printing on the front surface and the rear surface in this order, and the printed cut paper S is delivered to the delivery device 14 located above the feeder device 11. Accordingly, the entire length of the printing press can be reduced, and the feeder device 11 and the delivery device 14 can be efficiently arranged, which enables a feeding operation and a delivery operation to be performed at the same position. This reduces burdens on operators and enables the entire printing press to be compact.

When the delivery device 14 is located above the feeder device 11, it is possible to arrange the feeder device 11 on the first floor and the delivery device 14 on the second floor, or arrange the delivery device 14 staked on the feeder device 11 on the first floor.

### Seventh Embodiment

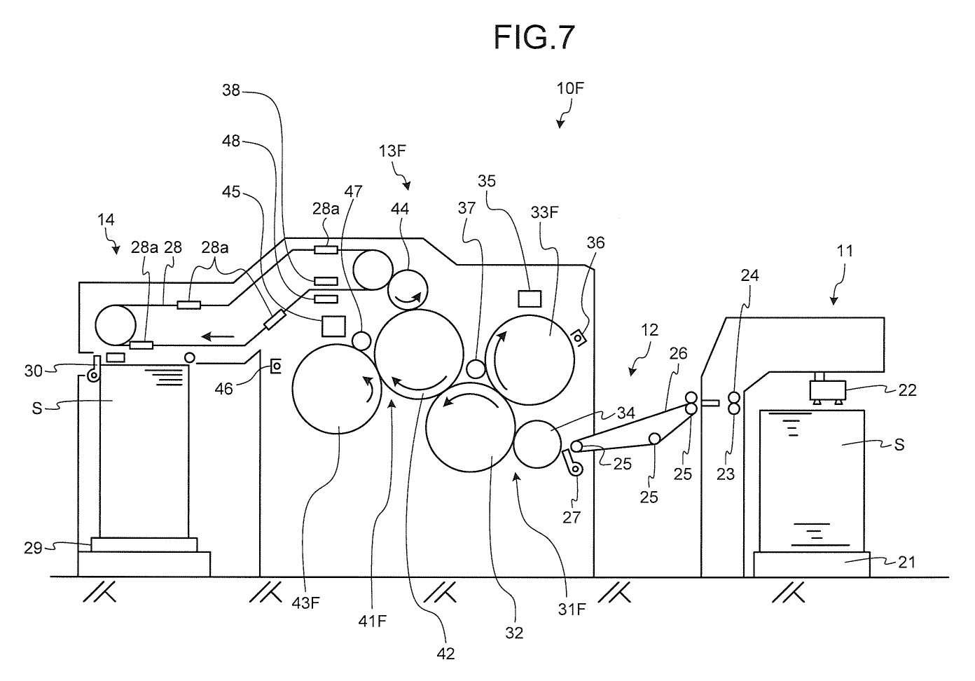

FIG. 7 is a schematic configuration diagram of an offset sheet-fed duplex printing press according to a seventh embodiment of the present invention. Members having functions identical to those described in the above embodiments are denoted by like reference signs and detailed explanations thereof will be omitted.

In the seventh embodiment, an offset sheet-fed duplex printing press 10F as a sheet-fed duplex printing press includes the feeder device 11, the carrying device 12, a printing device 13F, and the delivery device 14 as shown in FIG. 7. Because the feeder device 11, the carrying device 12, and the delivery device 14 according to the seventh embodiment are identical to those according to the first embodiment described above, explanations thereof will be omitted.

The printing device 13F represents a sheet-fed duplex printing press according to the present invention, and includes a front-surface printing unit 31F that prints on the front surface which is the first surface of the cut paper S and a rear-surface printing unit 41F that prints on the rear surface which is the second surface on the opposite side of the cut paper S from the first surface. In this case, the front-surface printing unit 31F is located upstream of the rear-surface printing unit 41F, and located on a lower side thereof and on a side of the feeder device 11.

The front-surface printing unit 31F has the first impression cylinder 32 and a first blanket cylinder 33F, and the first impression cylinder 32 contacts the intermediate cylinder 34. The first blanket cylinder 33F has a double diameter as the first impression cylinder 32, and the first ink jet head 35, the first heat lamp 36, and the first cleaning roller 37 are provided near the outer side thereof. The rear-surface printing unit 41F has the second impression cylinder 42 and a second blanket cylinder 43F. The second impression cylinder 42 contacts the first impression cylinder 32 and is connected to the chain gripper 28 of the delivery device 14 via the intermediate cylinder 44. The second blanket cylinder 43F has a double diameter as the second impression cylinder 42, and the second ink jet head 45, the second heat lamp 46, and the second cleaning roller 47 are provided near the outer side thereof.

In a printing method performed by the offset sheet-fed duplex printing press 10F according to the seventh embodiment, the ink jet heads 35 and 45 spray heatset ink onto the outer peripheral surfaces of the blanket cylinders 33F and 43F twice to form two images thereon while the blanket cylinders 33F and 43F rotate one revolution, and the images are sequentially transferred onto the cut paper S held by the impression cylinders 32 and 42, respectively. Other features in the seventh embodiment are almost the same as those in the first embodiment and thus explanations thereof will be omitted.

As described above, in the offset sheet-fed duplex printing press according to the seventh embodiment, the front-surface printing unit 31F and the rear-surface printing unit 41F are arranged in the printing device 13F in the carrying direction of the cut paper S, and the impression cylinders 32 and 42 and the blanket cylinders 33F and 43F are cylinders with double diameters.

Therefore, the cut paper S is subjected to printing on the front surface and the rear surface in this order. By using cylinders with double diameters as the impression cylinders 32 and 42 and the blanket cylinders 33F and 43F, spaces are created around the blanket cylinders 33F and 43F, which facilitates arrangement of the ink jet heads 35 and 45, the heat lamps 36 and 46, and the like, respectively.

While the impression cylinders 32 and 42 and the blanket cylinders 33F and 43F are cylinders with double diameters in the seventh embodiment, cylinders with triple or larger diameters can be used.

### Eighth Embodiment

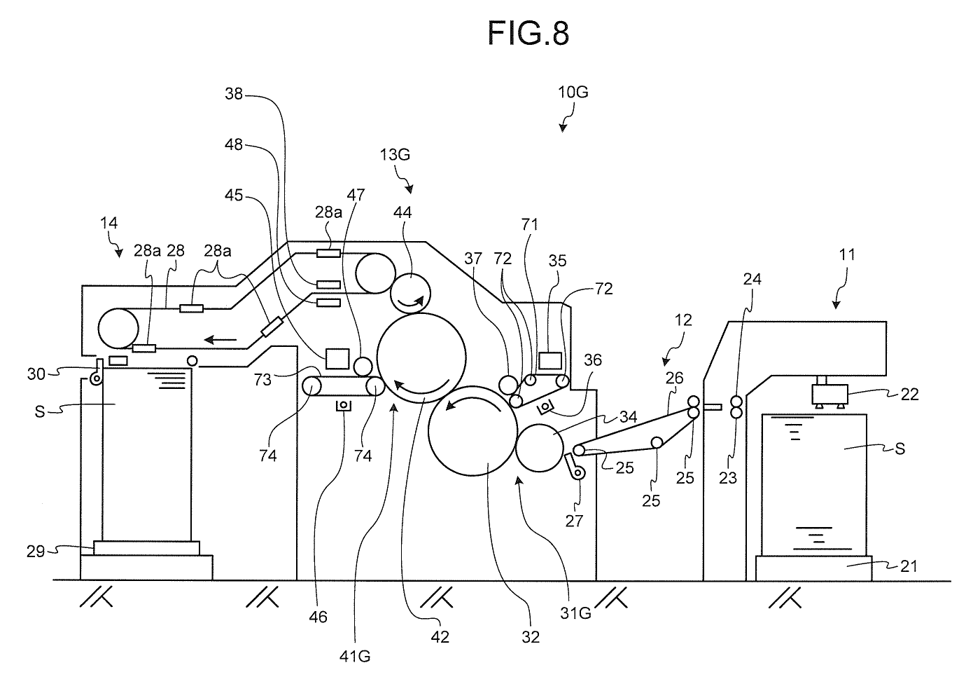

FIG. 8 is a schematic configuration diagram of an offset sheet-fed duplex printing press according to an eighth embodiment of the present invention. Members having functions identical to those described in the above embodiments are denoted by like reference signs and detailed explanations thereof will be omitted.

In the eighth embodiment, an offset sheet-fed duplex printing press 10G as a sheet-fed duplex printing press includes the feeder device 11, the carrying device 12, a printing device 13G, and the delivery device 14 as shown in FIG. 8. Because the feeder device 11, the carrying device 12, and the delivery device 14 according to the eighth embodiment are identical to those according to the first embodiment described above, explanations thereof will be omitted.

The printing device 13G represents a sheet-fed duplex printing press according to the present invention, and includes a front-surface printing unit 31G that prints on the front surface which is the first surface of the cut paper S and a rear-surface printing unit 41G that prints on the rear surface which is the second surface on the opposite side of the cut paper S from the first surface. In this case, the front-surface printing unit 31G is located upstream of the rear-surface printing unit 41G.

The front-surface printing unit 31G includes the first impression cylinder 32 and a first transfer belt 71, and the first impression cylinder 32 contacts the intermediate cylinder 34. The first transfer belt 71 is an endless rubber belt movably supported by three guide rollers 72, has a surface to which a blanket is attached, and contacts an outer peripheral surface of the first impression cylinder 32 with a predetermined nip pressure. The first ink jet head 35, the first heat lamp 36, and the first cleaning roller 37 are provided near the outer side of the first transfer belt 71. In this case, the first ink jet head 35 is located over the first transfer belt 71 and the first heat lamp 36 is located under the first transfer belt 71, which means that the first heat lamp 36 is located on an opposite side of the first transfer belt 71 from the first ink jet head 35.

The rear-surface printing unit 41G has the second impression cylinder 42 and a second transfer belt 73, and the second impression cylinder 42 contacts the first impression cylinder 32 and is connected to the chain gripper 28 of the delivery device 14 via the intermediate cylinder 44. The second transfer belt 73 is an endless rubber belt movably supported by two guide rollers 74, has a surface to which a blanket is attached, and contacts an outer peripheral surface of the second impression cylinder 42 with a predetermined nip pressure. The second ink jet head 45, the second heat lamp 46, and the second cleaning roller 47 are provided near the outer side of the second transfer belt 73. In this case, the second ink jet head 45 is located over the second transfer belt 73 and the second heat lamp 46 is located under the second transfer belt 73, which means that the second heat lamp 46 is located on an opposite side of the second transfer belt 73 from the second ink jet head 45.

In a printing method performed by the offset sheet-fed duplex printing press 10G according to the eighth embodiment, the ink jet heads 35 and 45 spray heatset ink to the outer peripheral surfaces of the transfer belts 71 and 73 to form images, and the images are transferred onto the cut paper S held by the impression cylinders 32 and 42, respectively. Configurations of the eighth embodiment other than the transfer belts 71 and 73 that are used instead of the blanket cylinders 33 and 43 are almost the same as those in the first embodiment and thus explanations thereof will be omitted.

As described above, in the offset sheet-fed duplex printing press according to the eighth embodiment, the front-surface printing unit 31G and the rear-surface printing unit 41G are arranged in the carrying direction of the cut paper S in the printing device 13G, and transfer bodies in the printing units 31G and 41G are the transfer belts 71 and 73, respectively.

Therefore, the cut paper S is subjected to printing on the front surface and the rear surface in this order, and by using the transfer belts 71 and 73 as the transfer bodies, the ink jet heads 35 and 45 and the heat lamps 36 and 46 can be more easily arranged around the transfer belts 71 and 73, thereby realizing a compact printing press. Furthermore, this arrangement enables the ink jet heads 35 and 45 to spray the heatset ink downward, which is the same direction as the gravity, and thus enables high-accuracy images to be formed on the surfaces of the transfer belts 71 and 73. As a result, high-accuracy duplex printing can be achieved.

In the offset sheet-fed duplex printing press of the eighth embodiment, the first and second heat lamps 36 and 46 are located on the opposite side of the first and second transfer belts 71 and 73 from the first and second ink jet heads 35 and 45, respectively. Therefore, effects of thermal energy of the heat lamps 36 and 46 on the ink sprayed from the ink jet heads 35 and 45 can be suppressed, which prevents clogging of the nozzles of the ink jet heads 35 and 45 and enables high-accuracy image formation by the spray of the ink.

### Ninth Embodiment

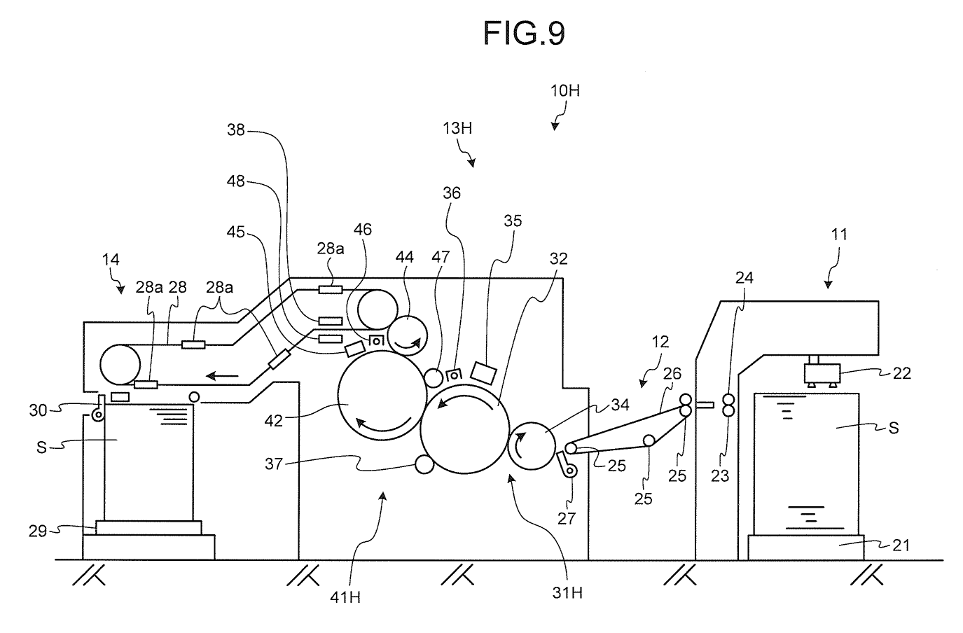

FIG. 9 is a schematic configuration diagram of an offset sheet-fed duplex printing press according to a ninth embodiment of the present invention. Members having functions identical to those described in the above embodiments are denoted by like reference signs and detailed explanations thereof will be omitted.

In the ninth embodiment, an offset sheet-fed duplex printing press 10H as a sheet-fed duplex printing press includes the feeder device 11, the carrying device 12, a printing device 13H, and the delivery device 14 as shown in FIG. 9. Because the feeder device 11, the carrying device 12, and the delivery device 14 according to the ninth embodiment are identical to those according to the first embodiment described above, explanations thereof will be omitted.

The printing device 13H represents a sheet-fed duplex printing press according to the present invention, and includes a front-surface printing unit 31H that prints on the front surface which is the first surface of the cut paper S and a rear-surface printing unit 41H that prints on the rear surface which is the second surface on the opposite side of the cut paper S from the first surface. In this case, the front-surface printing unit 31H is located upstream of the rear-surface printing unit 41H.

The front-surface printing unit 31H has the first impression cylinder 32, and the first impression cylinder 32 contacts the intermediate cylinder 34. The first ink jet head 35, the first heat lamp 36, and the first cleaning roller 37 are provided near the outer side of the first impression cylinder 32. In this case, the first ink jet head 35 is located over the first impression cylinder 32. The rear-surface printing unit 41H has the second impression cylinder 42, and the second impression cylinder 42 contacts the first impression cylinder 32 and is connected to the chain gripper 28 of the delivery device 14 via the intermediate cylinder 44. The second ink jet head 45, the second heat lamp 46, and the second cleaning roller 47 are provided near the outer side of the second impression cylinder 42. In this case, the second ink jet head 45 is located over the second impression cylinder 42.

In a printing method performed by the offset sheet-fed duplex printing press 10H according to the ninth embodiment, the ink jet heads 35 and 45 spray heatset ink directly to the front and rear surfaces of the cut paper S which is carried being held by the impression cylinders 32 and 42 to form images thereon, and the heat lamps 36 and 46 apply the light and heat to the images to primarily dry (semi-dry) the ink, respectively. Configurations of the ninth embodiment other than the elimination of the transfer bodies are almost the same as those of the first embodiment and thus explanations thereof will be omitted.

As described above, in the offset sheet-fed duplex printing press according to the ninth embodiment, the front-surface printing unit 31H and the rear-surface printing unit 41H are arranged in the carrying direction of the cut paper S in the printing device 13H, and the ink jet heads 35 and 45 in the printing units 31H and 41H spray the heatset ink directly to the front and rear surfaces of the cut paper S which is held by the impression cylinders 32 and 42 to form images thereon, respectively.

Therefore, the cut paper S is subjected to printing on the front surface and the rear surface in this order and a compact printing press can be realized by eliminating the transfer bodies. Furthermore, this arrangement enables the ink jet heads 35 and 45 to spray the heatset ink downward, which is the same direction as the gravity, and enables high-accuracy images to be formed on the surfaces of the impression cylinders 32 and 42, respectively. As a result, high-accuracy duplex printing can be achieved.

Also in a direct printing method in which the ink jet heads 35 and 45 spray the heatset ink directly to the front and rear surfaces of the cut paper S to form images as in the printing device 13H of the offset sheet-fed duplex printing press according to the ninth embodiment, the cylinder arrangement and device arrangement according to an indirect method using the transfer bodies as in the first to eighth embodiments mentioned above can be adopted.

While a variety of embodiments of cylinder arrangements and device arrangements has been explained in the first to ninth embodiments, the present invention is not limited to these embodiments and it is possible to combine these embodiments.

While the heatset ink is used as the ink and the heating devices are used as the drying devices in the embodiments mentioned above, the present invention is not limited to this configuration and it is possible to use common water-based ink or oil-based ink and to use hot-air drying devices as the drying devices or use no drying device.

In the present invention, paper does not need to be used and the cut paper can be replaced by a resin film, a steel sheet, or the like.

While the sheet-fed duplex printing press according to the present invention is assumed in the embodiments mentioned above to be a printing press that performs printing by only using the ink jet heads, the sheet-fed duplex printing press according to the present invention can be applied to a part of a printing press. For example, printing by using ink jet heads can be performed on the cut paper that has been printed by a sheet-fed offset print unit. Furthermore, on the cut paper that has been printed by a sheet-fed offset printing press, another sheet-fed duplex printing press according to the present invention can perform printing.

### INDUSTRIAL APPLICABILITY

As described above, the sheet-fed duplex printing press according to the present invention enables printing continuously on the front and rear surfaces of the cut paper, thereby achieving high-accuracy duplex printing, and can be applied to any kind of sheet-fed printing presses.

### REFERENCE SIGNS LIST

10, 10A, 10B, 10C, 10D, 10E, 10F, 10G, 10H OFFSET SHEET-FED DUPLEX PRINTING PRESS
11 FEEDER DEVICE
12 CARRYING DEVICE
13, 13A, 13B, 13C, 13D, 13E, 13F, 13G, 13H PRINTING DEVICE
14 DELIVERY DEVICE
31, 31A, 31B, 31C, 31D, 31E, 31F, 31G, 31H FRONT-SURFACE PRINTING UNIT
32 FIRST IMPRESSION CYLINDER (FIRST PRINTING CYLINDER)
33 FIRST BLANKET CYLINDER (FIRST TRANSFER BODY, FIRST TRANSFER CYLINDER)
35 FIRST INK JET HEAD
36 FIRST HEAT LAMP (FIRST HEATING DEVICE, FIRST DRYING DEVICE)
41, 41A, 41B, 41C, 41D, 41E, 41F, 41G, 41H REAR-SURFACE PRINTING UNIT
42 SECOND IMPRESSION CYLINDER (SECOND PRINTING CYLINDER)
43 SECOND BLANKET CYLINDER (SECOND TRANSFER BODY, SECOND TRANSFER CYLINDER)
45 SECOND INK JET HEAD
46 SECOND HEAT LAMP (SECOND HEATING DEVICE, SECOND DRYING DEVICE)
61, 63 PRESS CYLINDER
71 FIRST TRANSFER BELT (FIRST TRANSFER BODY)
73 SECOND TRANSFER BELT (SECOND TRANSFER BODY)

1. A sheet-fed duplex printing press that performs duplex printing by supplying ink to a first surface of cut paper and a second surface on an opposite side thereof from the first surface, the sheet-fed duplex printing press comprising:
a first printing cylinder that can carry the cut paper by rotating while holding the cut paper;
a first transfer body that contacts the first printing cylinder and can transfer ink onto the first surface of the cut paper;
a first ink jet head that can supply the ink to the first transfer body;
a second printing cylinder that contacts the first printing cylinder directly or via an intermediate cylinder and can carry the cut paper by rotating while holding the cut paper;
a second transfer body that contacts the second printing cylinder and can transfer ink to the second surface of the cut paper; and
a second ink jet head that can supply the ink to the second transfer body.

2. The sheet-fed duplex printing press according to claim 1, wherein the first and second ink jet heads are located over the first and second transfer bodies, respectively.

3. The sheet-fed duplex printing press according to claim 1, wherein the first printing cylinder and the second printing cylinder are located at positions vertically shifted from each other.

4. The sheet-fed duplex printing press according to claim 1, wherein the first and second printing cylinders have a circumference that is set to an integral multiplex of that of the first and second transfer bodies.

5. The sheet-fed duplex printing press according to claim 1, further comprising first and second drying devices that primarily dry the ink supplied to the first and second transfer bodies, respectively.

6. The sheet-fed duplex printing press according to claim 5, further comprising third and fourth drying devices that secondarily dry the ink transferred from the first and second transfer bodies onto the cut paper, respectively.

7. The sheet-fed duplex printing press according to claim 6, wherein the first and second ink jet heads can supply heatset ink to peripheral surfaces of the first and second transfer bodies, and the first to fourth drying devices are first to fourth heating devices, respectively.

8. The sheet-fed duplex printing press according to claim 7, wherein the first and second heating devices are located on opposite sides of the first and second transfer bodies from the first and second ink jet heads, respectively.
